(19) United States
(12) Patent Application Publication
(10) Pub. No.: US 2008/0129980 A1
(43) Pub. Date: Jun. 5, 2008

(54) IN-LINE FIBER OPTIC SENSOR DEVICES AND METHODS OF FABRICATING SAME

(75) Inventors: ANUJ DHAWAN, Raleigh, NC (US); John Muth, Cary, NC (US)

Correspondence Address: TROUTMAN SANDERS LLP, 600 PEACHTREE STREET , NE, ATLANTA, GA, 30308, US

(73) Assignee: NORTH CAROLINA STATE UNIVERSITY

(21) Appl. No.: 11/948,970

(22) Filed: Nov. 30, 2007

Related U.S. Application Data
(60) Provisional application No. 60/868,084, filed on Nov. 30, 2006.

(51) Int. Cl. G01C 3/14

(52) U.S. Cl. 356/12

(57) ABSTRACT

In-line fiber optic structure devices for use as environmental sensors and methods of fabricating in-line fiber optic structures as environmental sensors are disclosed and provided. According to some embodiments, fiber optic sensor devices can utilize the interaction of surface plasmons or evanescent waves with a surrounding environment. Fiber optic sensors according to some embodiments of the present invention provide an optical fiber with a long environmental interaction length having improved structural integrity. Graded-index optical fiber elements can be used as lenses and a coreless optical fiber element can act as an environmental interaction or sensing area. Graded-index and coreless optical elements can be fused to provide a continuous fiber optic sensing system. Other various embodiments are also claimed and described.

### CROSS REFERENCE TO RELATED APPLICATION & PRIORITY CLAIM

This application claims priority to and the benefit of U.S. Provisional Application No. 60/868,084 filed on 30 Nov. 2006, which is incorporated herein by reference in its entirety as if fully set forth below.

### TECHNICAL FIELD

The various embodiments of the present invention relate generally to fiber optics, and more particularly, to in-line fiber optic structures and methods for fabricating in-line fiber optic structure devices. Such structures can be used as environmental sensors.

### BACKGROUND

In typical fiber optic applications, light in an optical fiber is confined to the core of a waveguide. A cladding layer typically thicker than the optical fiber core is used to minimize light interaction with ambient environment in an effort to keep light within the waveguide for increased efficiencies. The thickness of the cladding is also typically used to provide mechanical strength to fiber optic cables.

As is known, optical fibers have been used as sensors in for a wide variety of sensor applications. For example in a Bragg grating, a periodic variation of refractive index in a fiber's core can be used to measure mechanical strains and in this sensor application, light does not leave the fiber's core. Examples of where light interaction with a surrounding environment are evanescent wave and surface plasmon optical sensors, in which an electromagnetic wave (e.g., light) carried by a fiber is allowed to extend beyond the glass-air interface. This interaction enables environmental sensing to occur.

Environmental sensing generally includes detecting changes in refractive index or mass loading due to a change in a surrounding medium in contact with, or in close proximity to a fiber. For example, this can be a change in refractive index due to a change in a fluid's chemical composition. Another example includes changing optical properties of a medium surrounding a fiber such as the binding of a biological or other molecule to the surface of the fiber directly or by binding via an intermediate molecule. This sensor can detect proteins or DNA fragments. Environmental sensing can also include sensing temperature.

A variety of conventional strategies are currently used to allow optical fibers to interact with an external environment. These strategies include tapering of fibers (e.g., see FIG. 1), chemical etching a part of the optical fiber cladding (e.g., see FIG. 2), and mechanical polishing optical fibers. Although sensors based on current techniques work for their intended purposes, these strategies often greatly affect the physical integrity of optical fibers thereby making fibers that are fragile and susceptible to damage.

For example, and as shown in FIG. 1, tapering of a fiber for environmental sensing reduces the thickness of the fiber thereby making the glass fiber very thin (e.g., 20 to 30 microns). As another example, chemical etching to remove a fiber's cladding exposes the optical fiber's core. This reduces the fiber diameter to that of the core. This reduced dimension makes the structure very fragile as shown in FIG. 2. The etching process also lowers the mechanical strength of the glass making it susceptible to fracture. As a result, it can be difficult to deploy tapered and thinned fiber for remote environmental sensing or incorporated into flexible substrates due to a weakened physical state.

Other currently used fiber sensors can be constructed on tips of optical fibers. Fabricating a sensor of this type can also yield a delicate fiber. Developing optical structures on fiber tips limit environmental interaction and therefore reduce sensing capabilities. In addition, these drawbacks usually require a signal to be monitored in reflection to sustain sensing capabilities.

What is needed, therefore, are fiber optic structures and associated fabrication methods that can provide fiber optical sensing devices and systems having improved structural strength. There is also a need for fiber optic structures and associated manufacturing processes that provide optic sensing capabilities within an optical fiber, such as in-line sensing capabilities, that can provide improved sensing capabilities. It is to the provision of such in-line fiber optical structures for environmental sensing and methods for fabricating in-line fiber optical structure devices for use as environmental sensors that the various embodiments of the present invention are directed.

### SUMMARY

Various embodiments of the present invention are directed to fiber optic structures and associated fabrication methods that can provide fiber optical sensing systems having improved structural strength. For example, various embodiments of the present invention provide a fiber optic structure that maintains the structural integrity of the optical fiber with a long environmental interaction length.

Also, according to some embodiments, graded-index optical fiber elements can be used as lenses, and a coreless optical fiber can be used as an environmental interaction area. Graded-index optical fiber elements and a coreless optical fiber element can be joined, coupled, or otherwise fused together to provide a sensing system. For example, the optical fiber elements can be joined or spliced and result in a continuous fiber optic sensing system.

Other advantageous features of the various embodiments of the present invention relate to environment sensing regions. Optical fiber sensors according to embodiments of the present invention provide a large interaction or sensing regions as compared to tip based sensors, tapered fiber sensors, and conventional sensors. Advantageously increasing size of the interaction or sensing regions provides fiber optic sensors with enhanced sensing characteristics. Also according to some embodiments of the present invention, the size of the interaction region can be varied easily (e.g., by using a different length of coreless fiber) for different applications as desired.

Generally described, an in-line optical fiber sensor device to sense environmental information can comprise an optical input portion, an optical collector portion, and environmental sensing region. The optical input portion, the optical collector portion, and the environmental sensing region are preferably operatively configured to carry an optical signal (such as light). The environmental sensing region can be disposed between the input portion and the collector portion. As a result, the input portion can provide an optical signal to the environmental sensing region and the collector portion can receive an optical signal from the environmental sensing region. The environmental sensing region can be configured to have a thickness substantially equal to the thickness of the optical input portion and the optical collector portion. Also, the outer surfaces of the optical input portion, the optical collector portion, and the environmental sensing region can be aligned in a substantially co-planar arrangement. The optical input portion and the optical collector portion can consist of a single mode fiber, a multimode fiber, a step index fiber, a graded index fiber, or a photonic crystal fiber.

In-line optical fiber sensor devices according to the present invention can also include additional features. For example, the environmental sensing region substantially can be a coreless optical fiber coupled to the optical input portion and the optical collector portion to form a continuous fiber optic sensor. As another example, a sensor device can comprise a lens. The lens can be disposed between the optical input portion and the environmental sensing region or the environmental sensing region and the optical collector portion. Preferably the lens can be operatively configured to alter an optical signal passing through the lens. Also, the length of the lens can be varied to so that the lens can be a diverging or converging lens. A sensor device can also comprise a matching index material. The material can be disposed within the optical input portion and the optical collector portion to match refractive indices associated with varying fiber components.

In-line optical fiber sensor devices according to the present invention can also further include additional features. For example, an in-line optical fiber sensor can include a light focusing element disposed between the optical input portion and the environmental sensing region. The light focusing element can be configured to change the flow of an optical signal such that the signal can be modified to converge and/or diverge from an initial state. Also, the light focusing element can be operatively configured to control at least a portion of an optical signal exiting the environmental sensing region and interacting with a surrounding environment. As another example, an in-line optical fiber sensor can include a light focusing element disposed between the environmental sensing region and the optical collector portion. The light focusing element can be operatively configured to control at least a portion of the optical signal entering the environmental sensing region from a surrounding environment. The light focusing elements can comprise at least one of a graded index fiber, a series of graded index fibers, a coreless fiber, or a nanostructure array.

Other features are also contemplated for other embodiments of in-line sensors of the present invention. For example, an in-line sensor can comprise an input lens or an output lens. The input lens can be spliced to an end of the environmental sensing region proximate the optical input portion. Also, the output lens can be spliced to an end of the environmental sensing region proximate the optical collector portion. As discussed herein, the input lens and the output lens can be operatively configured to control an optical signal passing therethrough. Some in-line sensor embodiments can also include a plasmonic lens disposed proximate an end of the environmental sensing region. The plasmonic lens can comprise a nanohole surrounded by a nanostructure array or a metallic film. The nanohole can be centrally placed on the surface of the plasmonic lens. Still yet, an in-line sensor embodiment can include a nanostructure array disposed proximate an outer surface of the environmental sensing region. The nanostructure array can correspond to a predetermined optical signal wavelength. Such an advantageous feature enables multiple sensors to be distinguished from one another and also a single sensor to sense for multiple occurrences.

Some embodiments of the present invention also include methods to fabricate an in-line optical fiber sensor to sense environmental information corresponding to an environment. For example, certain fabrication methods can generally include providing an input fiber component and a collector fiber component both adapted to carry an optical signal and providing a sensing fiber component adapted to carry an optical signal and having a diameter substantially equal to the input fiber component and the collector fiber. A method can also include disposing the sensing fiber component between the input fiber component and the collector fiber component such that the input fiber component. Such a configuration enables the sensing fiber component, and collector fiber component to form a continuous in-line optical fiber sensor.

Other method features are also contemplated in accordance with embodiments of the present invention. For example, a method can include providing a coreless optical fiber or a porous material component as the sensing fiber component. Also a method can include providing a lens proximate an end of the sensing fiber component. The lens can be configured to alter an optical signal passing through the lens such that light at certain angles exits the lens. A method can also include providing at least one of a nanostructure array on an outer surface of the sensing fiber component or a nanostructure array proximate at least one end of the sensing fiber component. Still yet, a method can include providing at least one of a porous component or a transparent component as the sensing fiber component such that an optical signal passing through the porous component can interact with a media.

Other embodiments of the present invention are directed to fiber optic sensing systems. Such systems can include a plurality of environmental fiber optic sensors for sensing information associated with a surrounding environment corresponding to the plurality of environment fiber optic sensors. For example, a sensing system can generally comprise a first fiber optical sensor placed at a first location in a fiber optic waveguide and a second fiber optical sensor placed at a second location in the fiber optic waveguide. The first fiber sensor can comprise a first environmental sensing region incorporating a first metallic structure. The first metallic structure can be adapted to enable an optical signal to interact with a surrounding environment and produce a resulting optical signal of a first predetermined wavelength. The second fiber sensor can comprise a second environmental sensing region incorporating a second metallic structure. The second metallic structure can be adapted to enable an optical signal to interact with a surrounding environment and produce a resulting optical signal of a second predetermined wavelength.

Sensors in a sensing system can also include other features. For example, sensors in a sensing system can have components sized and shaped such that their outer surfaces are substantially co-planar. Sensors in a sensing system can also include a lens (or lensing element). The lens can be disposed proximate at least one end of the coreless optical fiber. The lens can be operatively configured to modify spread characteristics of an optical signal passing through the lens for entry into or exit out from an environmental sensing region.

To describe certain embodiments and features of the present invention, the inventors may use certain positioning and location words and abbreviations herein. For example, sometimes the words couple and proximate (or variants thereof) are used. Use of these words is indented to encompass not only direct physical location or contact but also close proximity (i.e., indirect physical location or physical contact). As a result, certain features discussed herein can be coupled or proximate directly or indirectly. Regarding abbreviations, these are at times used herein and in the drawings. Used abbreviations include: MMF to refer to a multimode fiber; CF to refer to a coreless fiber; GIF to refer to a graded index fiber; and SMF to refer to a single mode fiber. Other abbreviations, such as periodic element abbreviations, may also be utilized.

Other aspects and features of embodiments of the present invention will become apparent to those of ordinary skill in the art, upon reviewing the following description of specific, exemplary embodiments of the present invention in conjunction with the accompanying figures.

### BRIEF DESCRIPTION OF FIGURES

FIG. 1 illustrates a cross-sectional view of a conventional fiber optic element having a gold coated tapered fiber section for use as an environmental sensor.

FIG. 2 illustrates a cross-sectional view of a conventional fiber optic element with a section of cladding removed and a gold/silver coat applied to the exposed fiber section for use as an environmental sensor.

FIG. 3 illustrates a cross-sectional view of a diagram representing an environmental sensing device according to some embodiments of the present invention and an associated ray diagram.

FIG. 4 illustrates a cross-sectional view of a diagram representing an environmental sensing device according to some embodiments of the present invention and an associated ray diagram.

FIG. 5 illustrates a cross-sectional view of another diagram representing an environmental sensing device according to some embodiments of the present invention.

FIG. 6 illustrates a cross-sectional of yet another diagram representing an environmental sensing device according to some embodiments of the present invention.

FIG. 7 illustrates an exploded, cross-sectional view of still yet another diagram representing an environmental sensing device according to some embodiments of the present invention.

FIG. 8 illustrates a cross-sectional view of still yet another diagram representing an environmental sensing device according to some embodiments of the present invention.

FIG. 9 illustrates a perspective view of a diagram showing a system to receive data sensed using in-line fiber optical sensor devices according to some embodiments of the present invention.

FIG. 10 illustrates a perspective view of a diagram showing another system to receive data sensed using in-line fiber optical sensor devices according to some embodiments of the present invention.

FIG. 11 illustrates a perspective view of diagram of an environmental sensing system incorporating a plurality of in-line fiber optical sensor devices according to some embodiments of the present invention.

FIG. 12 illustrates a flow diagram of a method to fabricate an in-line fiber optical sensor device to sense a surrounding environment according to some embodiments of the present invention.

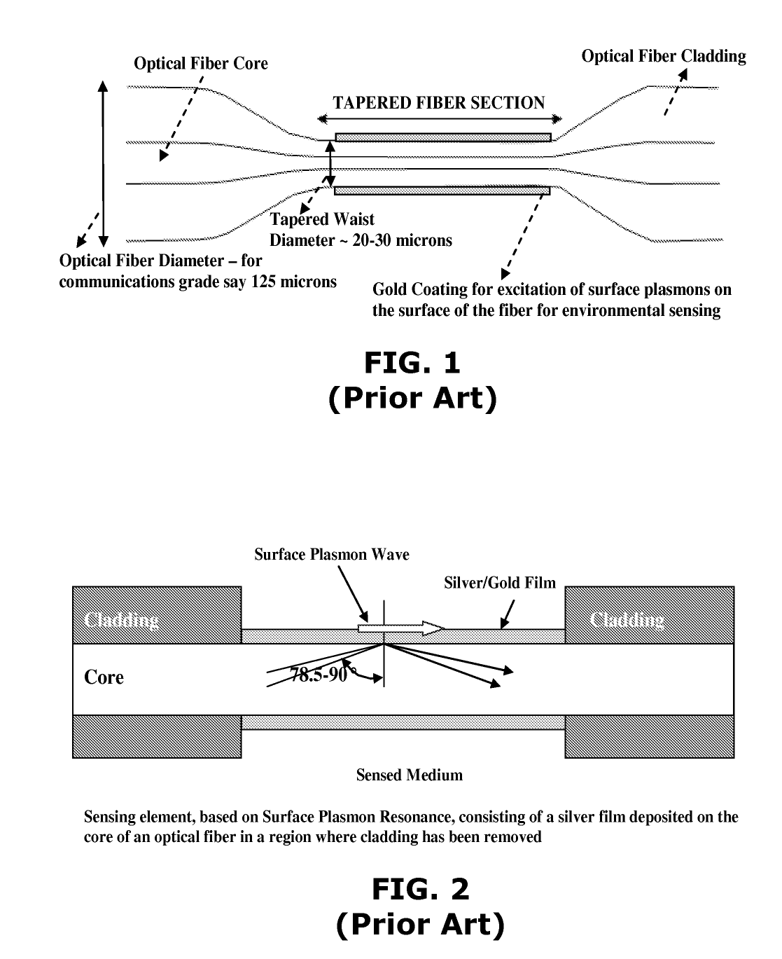

### DETAILED DESCRIPTION OF PREFERRED & ALTERNATIVE EMBODIMENTS

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented.

The various embodiments provide many numerous advantageous features over conventional optical sensors. For example, embodiments of the present invention provide in-line fiber optic structures that can serve as a platform for environmental sensing. Also embodiments of the present invention provide robust environmental sensors fabricated in such a manner so that the fabrication process does not significantly weaken the fiber structure. Still yet, embodiments of the present invention provide optical affinity sensors for environmental sensing which includes but are not limited to sensing of chemicals, biological molecules, temperature, as well as other environmental information. Some embodiments can also be used in applications including but not limited to switches, modulators, and other applications where changes or alterations in light can provide pertinent data.

By developing and utilizing optical sensor structures that include a coreless fiber (CLF) and an associated lens, precise control of light propagating in the coreless fiber can be obtained. Preferably, CLF regions enable light within the fiber to interact with a fiber's surrounding environment for sensing purposes. Another advantage of embodiments of the optical fiber sensor described herein is that a sensor can include a large interaction or sensing region as compared with the conventional optical sensors such as tip based sensors, tapered fiber sensors, or other kinds of conventional fiber-optic sensors. Another advantage is that the size of the interaction (or environmental sensing) region can be varied easily (e.g., by using a different length of a coreless fiber) as desired for different applications.

Some embodiments of the present invention can also be used in transduction sensing methods and systems. For example, transduction of light traveling in a fiber could be via evanescent waves only or different dielectric materials can be deposited on the surface of the optical fiber sensors. Such materials include, but are not limited to, metals or semiconductors. Transduction sensing methods and systems can be utilized for different environmental sensing applications. The deposited materials used according to the various embodiments of the present invention can have many different features. For example, these materials could be deposited as continuous films or as nanostructures. Exemplary nanostructures, include but are not limited to, nanoparticles, nanorods, nanorings nanowires, and nanoholes.

Transduction can be accomplished in numerous manners according to the various embodiments of the present invention. One exemplary manner includes excitation of surface plasmons due to a thin metallic/semiconducting film or nanoholes in a continuous film on a surface of an optical fiber in an interaction region of the fiber. Another exemplary transduction manner includes excitation of localized surface plasmons due to metallic/semiconductor nanostructures (e.g., nanoparticles, nanorods, nanowires, nanoislands, and nanorings) on a surface of an optical fiber in an interaction region of the fiber.

Another exemplary transduction manner includes excitations due to Fluorescence, Surface Enhanced Raman Scattering (SERS), and non-linear optical phenomena in the metallic/semiconductor nanostructures (nanoparticles, nanorods, nanopillars, nanowires, nanoholes in optically thick films, nanoislands, nanorings) on a surface of an optical fiber in an interaction region of the fiber.

Still yet another exemplary manner includes interaction of light propagating in a fiber with a material on the surface of the fiber. Properties of materials disposed on a fiber can be altered due to interaction when the material may go from one phase to another, the material may absorb light in certain spectral regions in the interaction region, or the interaction of light with the material on the coreless fiber surface may form quasiparticles such as excitons, plasmons, magon, or other phenonoma that can manifest themselves as a peak or valleys in a corresponding transmission or reflection spectrum. Material applied to a fiber can be a metal, alloy, or a semiconductor material, such as Vanadium oxide. The material may be in the form of a film or a nanostructure, and the material can alter or produce a change in the spectrum or intensity of light propagating through an optical fiber. As an example, this could be employed for temperature sensing if the material deposited on the surface of the fiber has a change in optical properties as a function of temperature (as is the case of Vanadium oxide).

FIG. 3 illustrates a perspective view of a diagram representing an environmental sensing device according to some embodiments of the present invention. Generally described, FIG. 3 illustrates a continuous optical fiber structure 300 that comprises several elements (or components) joined together to form a fiber optic sensing device. The several elements making up the continuous optical fiber structure 300 preferably have substantially equal thicknesses such that outer surfaces of the components are positioned in a substantially co-planar alignment. As used herein, substantially co-planar includes not only exactly co-planar but also contemplates a surface differential difference ranging from 0 to approximately 300 microns. Advantageously, such alignment provides a robust fiber optic sensing device, a continuous integral structure, and a device capable of deployment in many applications. It may also be desirable to vary sizes of fiber components so long as the interaction (environmental sensing regions) has a thickness greater than or equal to 50 microns. This advantageously ensures that the interaction region does not have a thickness reduced causing the fiber's physical structure to become fragile and susceptible to damage.

The various elements of the continuous optical fiber structure 300 can include varying types of fiber optical components. For example, and as shown, the fiber structure 300 can generally include a first graded-index optical fiber 305, a coreless fiber 310, and a second graded-index fiber 315. As shown, the coreless fiber 310 can be disposed between the two graded-index fibers 305, 315 such that the graded-index fibers 305, 310 are disposed proximate distal ends of the coreless fiber 310. Indeed, it is preferable that the coreless fiber 310 be coupled to the two graded-index fibers 305, 315 to create the continuous optical fiber structure 300. The components can be coupled together in many manners, including mechanical and fusion splicing. Advantageously, and as shown, the continuous fiber structure 300 can have approximately the same thickness across its length yielding a robust sensing device.

The continuous optical fiber structure 300 can also include other fiber optical elements. For example, the fiber structure 300 can include a first single-mode fiber 320 and a second single-mode fiber 325. The first single-mode fiber 320 can be an input and the second single-mode fiber can be an output. The first single-mode fiber 320 can be coupled to the first graded index fiber 305 proximate one end of the coreless fiber region 310 and the second single-mode fiber 325 can be coupled to the first graded index fiber 315 proximate another end of the coreless fiber region 310.

Other fiber structure embodiments can include other arrangements of fiber optical elements. These can include various types of fiber optic components of varying sizes, thickness, and characteristics. For example, fiber optic components positioned proximate a coreless fiber region can include a series of fiber optic elements of varying lengths, varying refractive indices, and varying materials. As specific examples, the fiber optic components can include but are not limited to a single mode fiber, a multimode fiber, a step index fiber, a graded index fiber, or a photonic crystal fiber. Other specific examples include a graded index fiber, a series of graded index fibers, a series of varying fiber types, a porous fiber component, and metallic layers. In some applications, it may be desirable to use an index matching material or a transparent material (e.g., a layer of silica) in coupling (or splicing) various elements together to form a continuous fiber optic sensing device.

FIG. 3 also illustrates a ray diagram schematic 350 of the continuous optical fiber structure 300 illustrating light transmission characteristics. As the schematic 350 illustrates, the fiber structure 300 can comprise lenses 305, 315, such as graded-index optical fibers 305, 315, to expand and collect an optical signal (e.g., a Gaussian beam). In other words, providing lensing elements (or light focusing elements) on ends of the coreless fiber region alters the spread characteristics of an optical signal for enhanced interaction with a surrounding environment. For example, an input lens can diverge the light in a wider area to direct it to the outer surface of the coreless fiber region and an output (or collector) lens can converge the light for transmission through a waveguide. The length of the lenses can be varied as desired to provide appropriate converging and diverging characteristics.

Directing and controlling an optical signal in this fashion advantageously enables a controllable interaction with a surrounding environment so that the fiber structure 300 can be used as an environmental sensor. For example, in the embodiment depicted in FIG. 3, the coreless fiber region 310 can be an environmental sensing region 355. The coreless fiber region is preferably comprised of a coreless optical fiber constructed with no cladding to allow an optical signal (e.g., light) to interact with an environment. The coreless fiber region 310 can receive light from a surrounding environment due to its cladless arrangement (i.e., no cladding layer). The arrangement and positioning of the graded index fibers 305, 310 can serve as lenses 360, 365 to alter light flow characteristics for enhanced sensing abilities.

As FIG. 3 also illustrates, the environmental sensing region 355 of the fiber structure 300 can have various lengths. For example, the diameter of the sensing region 355 can range from approximately 50 microns to approximately 600 microns and the length of the sensing region can range from approximately 100 microns to approximately 55 mm. Other physical configurations are also possible as desired. Improved sensing abilities are also enabled because the thickness dimensions of the fiber structure 300 have not been thinned or otherwise reduced in fabricating the fiber structure 300 as a sensing device.

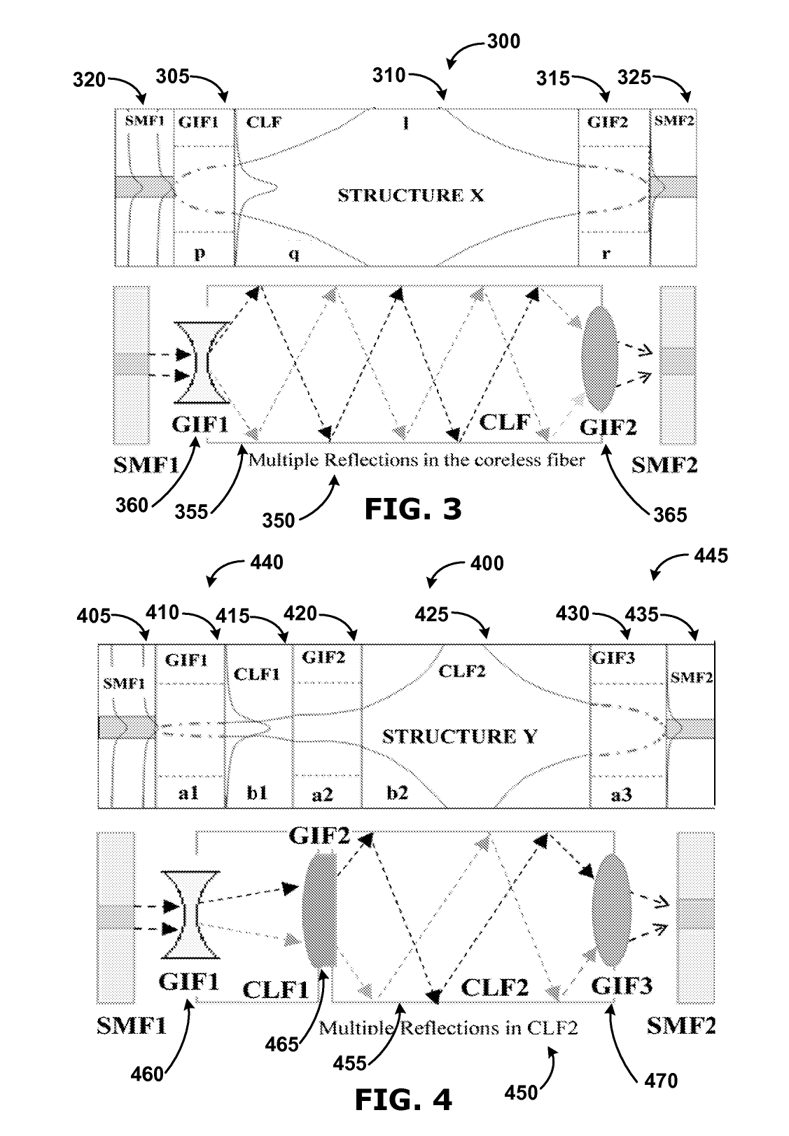

FIG. 4 illustrates a cross-sectional view of a diagram representing an environmental sensing device according to some embodiments of the present invention and an associated ray diagram. Indeed, FIG. 4 illustrates another possible optical structure 400 according to some embodiments of the present invention. The optical structure 400 can be composed of multiple graded index fiber elements, multiple coreless fiber elements, and multiple single mode fiber elements. As shown, the fiber elements can be joined, coupled, or fused together to form a continuous optic system used as an optical sensor device. The coreless fiber elements can have variable so that some coreless fiber elements have greater length than another utilized coreless fiber element, as shown in FIG. 4. When multiple coreless fiber elements are utilized, a longer coreless fiber element can be uses as an environmental interaction region.

Generally described, FIG. 4 illustrates a continuous fiber structure 400 that comprises several elements joined together. These elements can include a first single mode fiber 405, a first graded index fiber 410, a first coreless index fiber 415, a second graded index fiber 420, a second coreless index fiber 425, a third graded index fiber 430, and a second single mode fiber 435. The first single mode fiber 405, the first graded index fiber 410, the first coreless index fiber 415, and the second graded index fiber 420, can form an input portion 440 for providing an optical signal to the second coreless index fiber 425. The first coreless index fiber 415 can be configured to allow expansion (or divergence) of the light passing through it. Also, the third graded index fiber 430 and the second single mode fiber 435 can form an output (or collector) portion 445 to receive an optical signal from the second coreless index fiber 425.

FIG. 4 also illustrates a ray-tracing schematic 450 that generally corresponds to the optical structure 400. The angles of incidence are not to scale in the figure and remain greater than the critical angle of the glass-air interface. As shown, the graded index fibers 410, 420, and 430 can serve as lenses for diverging and converging an optical signal passing through the second coreless index fiber 425. In the embodiment depicted in FIG. 4, the second coreless index fiber 425 serves as an environmental sensing region 455. The environmental sensing region 455 advantageously enables a passing optical signal to interact with an external environment exterior to the environmental sensing region 455.

The input and output portions 440, 445 can have additional characteristics according to some embodiments of the present invention. As shown in FIG. 4, these portions can be disposed proximate an end of the environmental sensing region 455 and can comprise various components joined together. The components can be joined together in many ways including but not limited to mechanical coupling, splicing, corresponding groove sections, and the like. Due to varying characteristics of components it may be desirable to utilize an index matching substance (such as an index matching gel) at boundary portions of different optical fiber components when joining multiple components of the input and output portions 440, 445. Although not shown, the input and output portions 440, 445 can also include end portions of a fiber optic cable used to transmit one or more optical signals. In this way, the continuous fiber structure 400 is placed in line with a signal carrying fiber optic cable enabling the continuous fiber structure 400 to serve as a sensing device along the length of the signal carrying fiber optic cable. Alternatively, the input fiber 405 and the collector fiber 435 can be a signal carrying fiber optic cable.

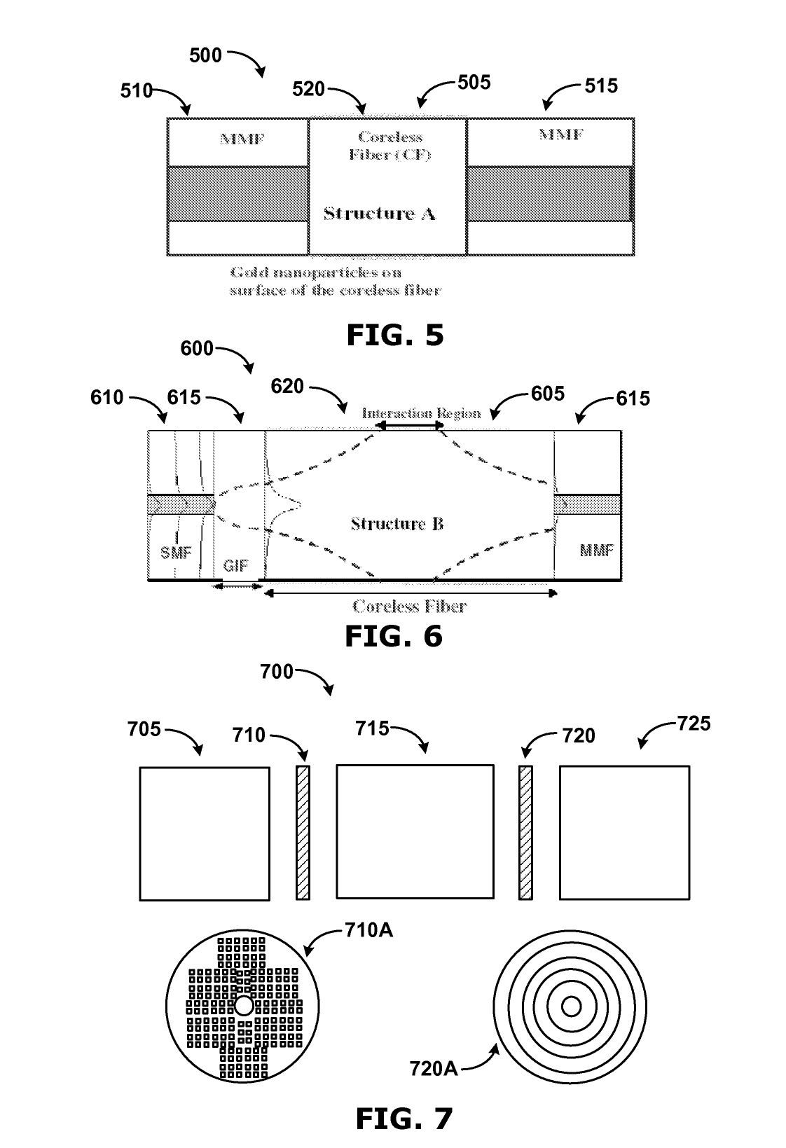

FIGS. 5 and 6 illustrate cross-sectional views of others diagrams representing sensing devices 500, 600 according to some embodiments of the present invention. Generally, both sensing devices 500, 600 include a coreless fiber region 505, 605 disposed between an input portion 510, 610 and an output portion 515, 615. The input portions 510, 610 and the output portions 515, 615 can be portions of a fiber optic cable. As shown, the input portions 510, 610 and the output portions 515, 615 can include one or more fiber optic elements. As with certain other embodiments of the present invention, the coreless fiber regions 505, 605 provide environmental interaction regions to enable environmental sensing. Also, the input portions 510, 610 and the output portions 515, 615 can be light focusing elements to change spread characteristics of an optical signal to advantageously enhance environmental sensing. As discussed below in more detail, the input portions 510, 610 and the output portions 515, 615 can be tailored to have certain physical characteristics to also aid in enhancing sensing abilities.

The sensing devices 500, 600 also include additional features enabling plasmonic sensing. As shown, the coreless fiber regions 505, 605 can include a film or layer 520, 620 disposed on the outer surfaces of the coreless fiber regions 505, 605. The films 520, 620 can be metallic films and affect an optical signal's interaction with a surrounding environment to alter and improve environmental sensing capabilities.

The films 520, 620 can take on a variety of shapes and include a variety of materials. For example, the films 520, 620 may be a nanostructure array. Exemplary nanostructure arrays include but are not limited to nanoholes or nanorings formed into a continuous metallic film, nanopillars, nanorods, nanowires, nanoislands, nano grating structures, or other such nanostructures. Exemplary materials can include metallic, conductive, or semiconductive materials. Specific material examples include but are not limited to Au, Ag, Cu, Pt, Pd, Ti, Cr, Zn, Al, Ni, Fe, V, W, Ru, Hf Zr, Ta, metal oxides, or combinations of these materials.

The films 520, 620 can be deposited onto the coreless fiber regions 505, 605 to form a predetermined nanostructure array. For example, metal deposition can be accomplished by E-Beam deposition, thermal evaporation, pulsed laser deposition, pulsed electron deposition, chemical vapor deposition, molecular beam epitaxy (MBE), metal organic chemical vapor deposition (MOCVD), atomic layer deposition, and hydrothermal processes etc.). Patterning can be accomplished by focused ion beam (FIB) milling, electron beam lithography, TEM lithography, annealing to form nanoislands (by thermal, laser, or plasma arc, or focused ion beam), or by chemical attachment of chemically prepared colloidal nanostructures of different sizes and shapes. Metallic and semiconducting nanostructures as well as semiconducting quantum dots can also be formed by one or more of pulsed laser deposition, pulsed electron deposition, chemical vapor deposition, molecular beam epitaxy (MBE), metal organic chemical vapor deposition (MOCVD), and atomic layer deposition. The metallic and semiconducting thin films can be formed by employing one or more deposition or film/nanostructure growth mechanisms such as E-Beam deposition, thermal evaporation, pulsed laser deposition, pulsed electron deposition, chemical vapor deposition, molecular beam epitaxy (MBE), metal organic chemical vapor deposition (MOCVD), atomic layer deposition, and hydrothermal processes.

FIG. 7 illustrates an exploded, cross-sectional view of still yet another diagram representing an environmental sensing device 700 according to some embodiments of the present invention. The sensing device 700 generally includes an input portion 705, a first plasmonic lens 710, an environmental sensing region 715, a second plasmonic lens 720, and an output (or collector) portion 725. The input and output portions 705, 725 can comprise one or more fiber optic components as discussed herein and also ends of a fiber optic waveguide for carrying an optical signal. The environmental sensing region 715 preferably comprises a coreless optical fiber to enable interaction with a surrounding environment without the need for altering the physical characteristics of a fiber optic waveguide. The environmental sensing region 715 may also comprise a porous region.

As shown, the first plasmonic lens 710 and the second plasmonic lens 720 can be disposed on opposing ends of the environmental sensing region 715. In some embodiments, the plasmonic lenses 710, 720 can be a component of the input and output portions 705, 725. In the embodiment depicted in FIG. 7, the plasmonic lenses 710, 720 are shown disposed between an end of the environmental sensing region 715 and a respective input or output portion 705, 725. For this placement, the plasmonic lenses 710, 720 may be formed on an exterior end surface of an input or output portion 705, 725, an exterior end surface of the environmental sensing region 715, or a combination of both.

The plasmonic lenses 710, 720 used in accordance with certain embodiments of the present invention provide additional advantageous features and can have various characteristics. For example, the plasmonic lenses 710, 720 may be thin layers or films made up of various materials, such as metals. The thickness of the material forming the plasmonic lens can range from approximately 80 nm to approximately 300 nm. As another example, the plasmonic lenses 710, 720 can include one or more nanostructure arrays formed on or into an exterior surface of the plasmonic lenses 710, 720. For example, and as shown by the exterior surface images 710A, 720A, the plasmonic lenses 710, 720 can include an array of nanostructures, such as nanoholes and nanorings formed on an exterior surface of the plasmonic lenses 710, 720. Spacing, sizing, and shaping of the nanostructures in a desired arrangement aids in allowing the plasmonic lenses 710, 720 to act as a converging or diverging lens. For example, the nanostructure arrays can be positioned in a periodic fashion so as to precisely control the converging or diverging nature of the plasmonic lenses 710, 720.

Also, and as illustrated, the exterior surfaces 710A, 720A of the plasmonic lenses 710, 720 can include a nanostructure array positioned around a central hole. The central hole is preferably formed through the entire thickness of the plasmonic lenses 710, 720, and can be generally displaced in a central location relative to the nanostructure array formed on the plasmonic lenses 710, 720. In some embodiments, the formed nanostructure arrays may consist of apertures, indentations, or pits formed in the surfaces of the plasmonic lenses 710, 720. Thus, in some embodiments, the nanostructure arrays are formed such that they do not extend through the entire thickness of the plasmonic lenses 710, 720.

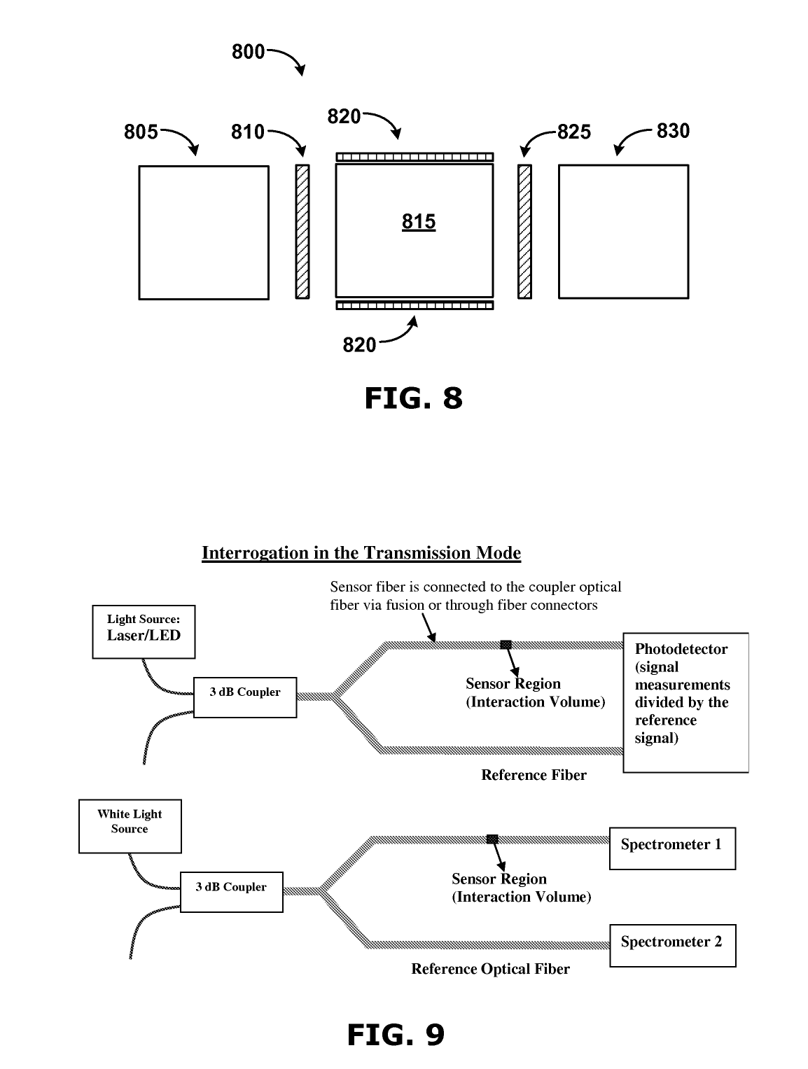

FIG. 8 illustrates a perspective view of still yet another diagram representing an environmental sensing device 800 according to some embodiments of the present invention. The device 800 generally includes an input portion 805, a first plasmonic lens 810, an environmental sensing region 815, a material layer 820, a second plasmonic lens 825, and an output (or collector) portion 830. The first plasmonic lens 810 and the second plasmonic lens 825 can be configured similarly as the plasmonic lensing elements discussed above in FIG. 7.

The material layer 820 may be applied to the entire outer surface of the environmental sensing region 815 or only to certain portions. For example, the material layer 820 can be disposed onto the environmental sensing region 815 as a nanostructure array. The nanostructure array can include an array of nanoholes, nanopillars, nanorings, nanorods, quantum dots, or nanoislands. In addition, the nanostructure array can be made of various types of different materials such that one set of nanostructures is made from one material and another set of nanostructure is made from another material. Such differing materials advantageously enable the environmental sensing region 815 to detect presence of multiple substances or detect substances in differing spectral regimes at a single sensor location. In other words, the environmental sensing region 815 can be configured to detect presence of multiple substances due to interaction with varying types of materials forming one or more arrays of nanostructures.

The surface of the environmental sensing region 815 can also be coated with metallic films that have periodic sub-wavelength nano aperture arrays or sub-wavelength periodic gratings such that the light traveling in the optical fiber can excite surface plasmons on both sides of the metallic film. Light emanating from the films containing the nanoapertures can interact with the environment around the sensor thereby modulating the plasmon resonance wavelength of the light traveling in the fiber. The semi-conducting materials, alloys, and other materials forming the nanostructures, films, and films containing the nanoaperture arrays can be selected such that they exhibit change of optical properties (such as refractive index, optical transmission, or polarization) upon increasing temperature around these films and nanostructures or other environmental changes as discussed herein.

FIGS. 9 and 10 illustrate perspective views of several exemplary systems to receive data sensed using in-line fiber optical sensor devices according to some embodiments of the present invention. There are various operational modes in accordance with embodiments of the present invention. Exemplary modes can include interrogation in transmission and interrogation in reflection as shown in FIGS. 9 and 10.

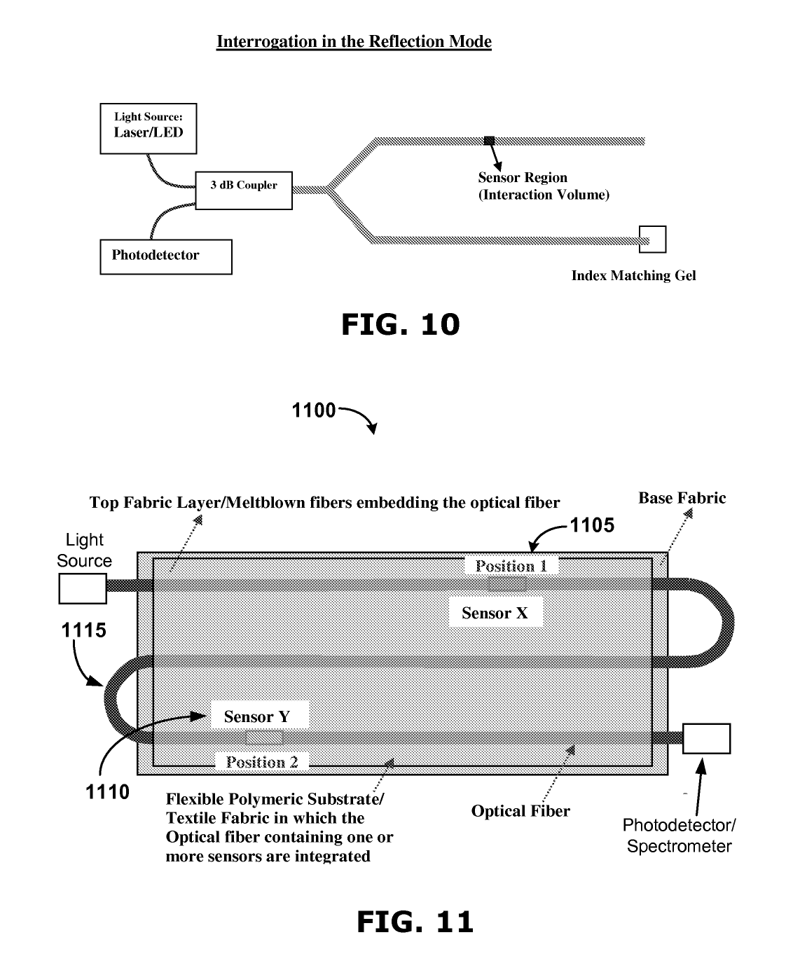

FIG. 11 illustrates a perspective view of diagram of an environmental sensing system 1100 incorporating a plurality of in-line fiber optical sensor devices according to some embodiments of the present invention. As shown, multiple in-line sensors 1105, 1110 are utilized in the optical sensing system 1100. The system 1100 can be deployed in various media, and as shown in this embodiment, the media can be a fabric or other flexible platform. As shown, the optical fiber sensors 1105, 1110 can be formed on or within the same optical fiber 1115. One or more of such fibers, with each fiber containing one or more sensors, could be integrated into a flexible platform such as a polymeric film or a textile fabric.

Integration of sensors in a flexible platform can occur by many different arrangements. These arrangements include but are not limited to: (1) weaving optical fibers into the fabric; (2) sandwiching sensor optical fiber between two layers of fabrics or polymeric films and applying heat or chemical means to hold the structure together; (3) or by placing a sensor optical fiber on a layer of a fabric and then depositing meltblown or electrospun fibers on top of the sensor optical fiber to embed/encapsulate the sensor fiber inside the fabric matrix. Other integration methods can also be utilized.

Other system sensing embodiments are also possible and contemplated with the present invention. Indeed, the sensing devices of the present invention can be utilized to sense and obtain a variety of environmental information from a variety of media. For example, sensing devices according to the present invention may be utilized as temperature sensors, chemical sensors, biological sensors, and biomedical sensors. Media types in which sensors of the present invention can be deployed include flexible fabrics (woven, knitted, or non-woven), polymeric films, ambient air environments, partial or full liquid environments, and ventilation ducts.

Moreover, different metallic (or a combination of metallic and semiconducting or metallic and dielectric materials) materials as well as alloys (or combination of more than one metallic material) could be employed to form different sensors used in the sensor system 1100 to engineer the plasmon resonance wavelength to be in the desired region of interest. Such features advantageously provide a way in which to distinguish one sensor from another spatially along the length of a fiber optic cable. For example, for metallic thin films (or a combination of metallic and semiconducting or metallic and dielectric materials), plasmon resonance related dips can be engineered by selecting appropriate film thickness and material. As another example, for semiconducting films and nanostructures, the geometry as well as the combination of materials employed could be engineered to provide a desired absorption edge (band edge) in transmission spectrum of the material. The engineering of the plasmon resonance wavelengths as well as the absorption edge (band edge) can be employed to match the spectral regimes of the light sources and detectors employed in the sensing.

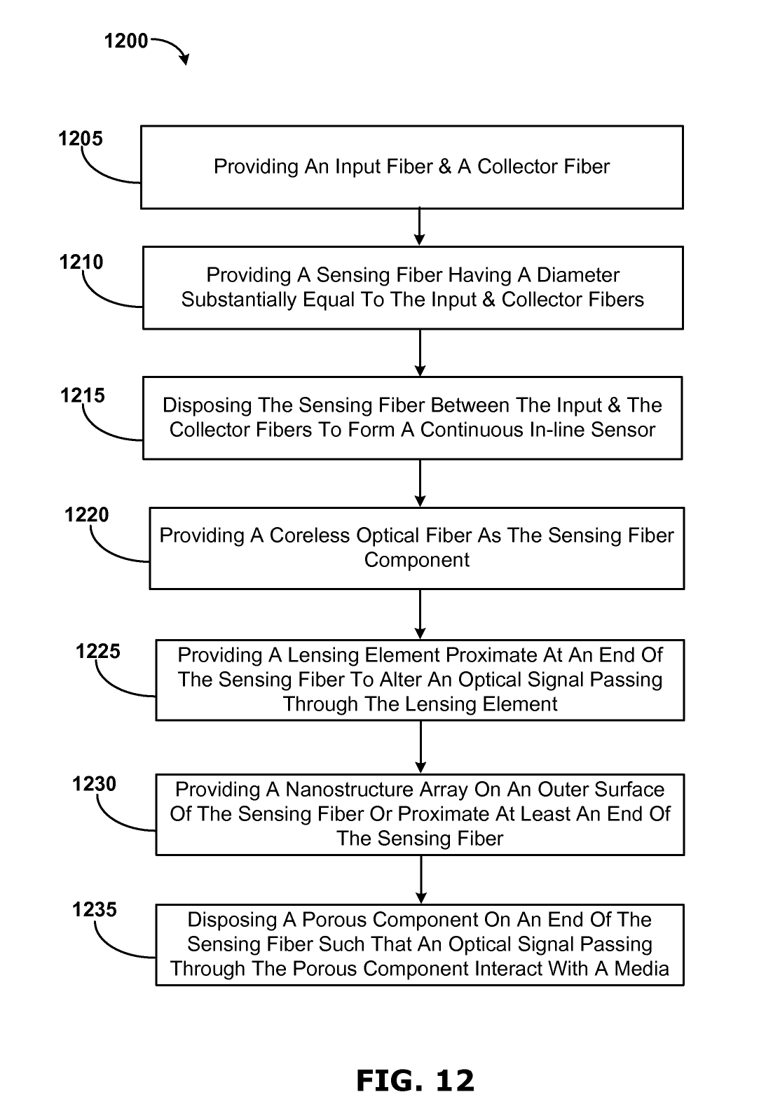

FIG. 12 illustrates a flow diagram of a method 1200 to fabricate an in-line fiber optical sensor device to sense a surrounding environment according to some embodiments of the present invention. Those skilled in the art will appreciate that method 1200 can be performed in various orders and that more or less actions can be performed in accordance with various method embodiments of the present invention.

The method 1200 can be a method to fabricate an in-line optical fiber sensor to sense environmental information. The method 1200 can include providing an input fiber component and a collector fiber component both adapted to carry an optical signal at 1205. The method 1200 can also include providing a sensing fiber component adapted to carry an optical signal and having a diameter substantially equal to the input fiber component and the collector fiber at 1210. The method 1200 can also include disposing the sensing fiber component between the input fiber component and the collector fiber component such that the input fiber component, sensing fiber component, and collector fiber component form a continuous in-line optical fiber sensor at 1215.

The method 1200 can also include additional features. For example, one action may include providing a coreless optical fiber as the sensing fiber component at 1220. As another example, the method 1200 can include providing a light focusing element proximate at least one of the ends of the sensing fiber component, the light focusing element operatively configured to alter an optical signal passing through the light focusing element at 1225. Still yet, the method 1200 may include providing at least one of a nanostructure array on an outer surface of the sensing fiber component or a nanostructure array proximate at least one end of the sensing fiber component at 1230. Still yet, the method 1200 may also include disposing a porous component on an end of the sensing fiber component such that an optical signal passing through the porous component can interact with a media at 1235.

Other fabrication features associated with material deposition are also contemplated in accordance with the present invention. For example, fiber optic sensors can be formed by coating an outer surface or one or more ends of the optical fibers with an optically thick layer of a metal or metal alloy. Then using focused ion beam milling a nanostructure array can be formed in the metal or metall alloy to produce sub-wavelength nanoapertures, for example. Advantageously, a plasmon resonance based nano-sensors can be produced in this manner and the nanostructure arrays can be fabricated reproducibly using focused ion beam milling system.

As mentioned above, fiber sensors according to embodiments of the present invention can include multiple fiber optic components. For example, varying types of optical fibers can be used. Exemplary step-index and graded-index optical fibers can be prepared by stripping a polymer jacket and cleaving the fiber with a handheld fiber cleaver to obtain a smooth surface. A smooth surface is preferable for bonding and splicing. Sample step-index multimode optical fibers include F-MLD fibers, obtained from Newport Corporation, with a 100 μm core and a 140 μm cladding diameter. Sample graded-index fibers employed in this work were obtained from 3M Corporation and had a 62.5 μm core and a 125 μm cladding diameter.

Various methods and systems can be used to apply metal or metallic alloys on a fiber. For example, electron beam evaporation can be used to coat fiber tips with 100 to 230 nm of metal or metal alloy depending on the experiment. In one arrangement, fiber tips can be mounted about 6 inches above a crucible. The sample mount can be rotated to improve uniformity and the thickness of the deposited film can be monitored by a quartz crystal monitor. The deposition rate can be varied between approximately 0.02 nm s⁻¹ and approximately 0.17 nm s⁻¹ at a chamber pressure of approximately 2×10⁻⁶ Torr. A slower rate of approximately 0.02 nm s⁻¹ can be employed for approximately 5-10 nm of film deposition such that there is better adhesion between the metal or metal alloy particles and a silica fiber surface. Metal or and metal alloys can be deposited on tapered step-index multimode fibers formed using a Sumitomo Electric fusion splicer by controlling the plasma arc duration and pull distance of the fiber clamps during the tapering process.

A Hitachi FB2100 Focused Ion Beam milling machine with a gallium ion source can be used to fabricate arrays of nanostructures. Beam currents and accelerating voltages of approximately 0.01 nA and approximately 40 keV energy can be used. A desired array of nanostructures can be milled by rastering an ion beam and employing a beam blanker. The beam blanker can be shut on and off according to a 8 bit grayscale, 512 by 512 pixel image file. The magnification can be varied between 6000 and 10000 depending on desired feature size.

In light of the above discussion, embodiments of the sensors described herein are extremely useful for developing inline optical fiber sensors having input fibers that are single mode fibers (with the core diameter normally less than approximately 10 microns) or multimode fibers that are mechanically flexible (for example multimode fibers that have a core diameter approximately 30-80 microns). Developing inline sensors that are flexible can enable easily embedding of these sensors in various substrates, including but not limited to polymer films, textiles, and concrete. Removing the cladding in single mode fibers or multimode fibers having the core diameter in the diameter range (30-150 microns) makes the optical fiber sensor fragile and compromises with the integrity of the inline sensor. If larger core (for example ˜150-600 micron core) fibers are employed, the optical fiber sensor is not mechanically flexible.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. An in-line optical fiber sensor device to sense environmental information, the device comprising:
an optical input portion and an optical collector portion, both portions operatively configured to carry an optical signal;
an environmental sensing region disposed between the input portion and the collector portion such that the input portion provides an optical signal to the environmental sensing region and the collector portion receives an optical signal from the environmental sensing region; and
the environmental sensing region configured to have a thickness substantially equal to the thickness of the optical input portion and the optical collector portion so that outer surfaces of the optical input portion, the optical collector portion, and the environmental sensing region are substantially co-planar.

2. The device of claim 1, the environmental sensing region substantially comprising a coreless optical fiber, the coreless optical fiber coupled to the optical input portion and the optical collector portion to form a continuous fiber optic sensor.

3. The device of claim 1, further comprising a lens disposed between at least one of (a) the optical input portion and the environmental sensing region; and (b) the environmental sensing region and the optical collector portion, the lens operatively configured to alter an optical signal passing through the lens.

4. The device of claim 1, wherein at least one of the optical input portion and the optical collector portion comprise at least one of a single mode fiber, a multimode fiber, a step index fiber, a graded index fiber, or a photonic crystal fiber.

5. The device of claim 4, further comprising a matching index material disposed generally within the at least one of the optical input portion and the optical collector portion to match refractive indices associated with varying fiber types.

6. The device of claim 1, further comprising a light focusing element disposed between the optical input portion and the environmental sensing region, the light focusing element operatively configured to control at least a portion of an optical signal exiting the environmental sensing region and interacting with a surrounding environment.

7. The device of claim 6, the light focusing element comprising at least one of a graded index fiber, a series of graded index fibers, a coreless index fiber, or a nanostructure array.

8. The device of claim 1, further comprising a light focusing element disposed between the environmental sensing region and the optical collector portion, the light focusing element operatively configured to control at least a portion of the optical signal entering the environmental sensing region from a surrounding environment.

9. The device of claim 8, the light focusing element comprising at least one of a graded index fiber, a series of graded index fibers, a series of coreless fibers, or a nanostructure array.

10. The device of claim 1, further comprising at least one of an input lens or an output lens, the input lens spliced to an end of the environmental sensing region proximate the optical input portion, the output lens spliced to an end of the environmental sensing region proximate the optical collector portion, and wherein the input lens and the output lens are operatively configured to control an optical signal passing therethrough.

11. The device of claim 1, further comprising a plasmonic lens disposed proximate an end of the environmental sensing region, the plasmonic lens comprising a nanohole surrounded by at least one of a nanostructure array or a thin film.

12. The device of claim 1, further comprising a nanostructure array disposed proximate an outer surface of the environmental sensing region, the nanostructure array corresponding to a predetermined optical signal wavelength.

13. A method to fabricate an in-line optical fiber sensor to sense environmental information corresponding to an environment, the method comprising:
providing an input fiber component and a collector fiber component both adapted to carry an optical signal;
providing a sensing fiber component adapted to carry an optical signal and having a diameter substantially equal to the input fiber component and the collector fiber; and
disposing the sensing fiber component between the input fiber component and the collector fiber component such that the input fiber component, sensing fiber component, and collector fiber component form a continuous in-line optical fiber sensor.

14. The method of claim 13, further comprising providing a coreless optical fiber as the sensing fiber component.

15. The method of claim 13, further comprising providing a lens proximate an end of the sensing fiber component, the lens operatively configured to alter an optical signal passing through the lens such that light at certain angles exits the lens.

16. The method of claim 13, further comprising providing at least one of a nanostructure array on an outer surface of the sensing fiber component or a nanostructure array proximate at least one end of the sensing fiber component.

17. The method of claim 13, further comprising providing at least one of a porous component or a transparent component as the sensing fiber component such that an optical signal passing through the porous component can interact with a media.

18. A fiber optic sensing system including at least a plurality of environmental fiber optic sensors for sensing information associated with a surrounding environment corresponding to the plurality of environment fiber optic sensors, the system comprising:
a first fiber optical sensor placed at a first location in a fiber optic waveguide, the first fiber sensor comprising a first environmental sensing region incorporating a first metallic structure adapted to enable an optical signal to interact with a surrounding environment and produce a resulting optical signal of a first predetermined wavelength; and
a second fiber optical sensor placed at a second location in a fiber optic waveguide, the second fiber sensor comprising a second environmental sensing region incorporating a second metallic structure adapted to enable an optical signal to interact with a surrounding environment and produce a resulting optical signal of a second predetermined wavelength.

19. The system of claim 18, wherein at least one of the first fiber optical sensor and the second fiber optical sensor comprise: an optical input portion, an optical collector portion, and a coreless optical fiber region disposed between the optical input portion and the optical collector portion, the coreless optical fiber region being sized and shaped such that outer surfaces of the optical input portion, the optical collector portion, and the coreless optical fiber are substantially co-planar.

20. The system of claim 19, further comprising a lens disposed proximate at least one end of the coreless optical fiber, the lens operatively configured to modify spread characteristics of an optical signal passing through the lens for entry into or exit out from the coreless optical fiber.
